(19) United States
(12) Patent Application Publication
(10) Pub. No.: US 2013/0127870 A1
(43) Pub. Date: May 23, 2013

(54) FOCUS-CHANGE INVARIANCE IN A GRAPHICAL DISPLAY

(71) Applicants: THOMAS BAUDEL, Paris (FR); BERTJAN BROEKSEMA, Gentilly (FR)

(72) Inventors: THOMAS BAUDEL, Paris (FR); BERTJAN BROEKSEMA, Gentilly (FR)

(73) Assignee: INTERNATIONAL BUSINESS MACHINES CORPORATION, Armonk, NY (US)

(21) Appl. No.: 13/363,547

(22) Filed: Feb. 1, 2012

(30) Foreign Application Priority Data
Nov. 23, 2011 (EP) 11306540.3

(51) Int. Cl. G06T 11/20

(52) U.S. Cl. 345/441

(57) ABSTRACT

A method for focus-change invariance in a graphical display may include computing selected items in the graphical display for presentation of each item in a predetermined geometric shape. The predetermined geometric shape may include a set of predetermined coordinates in a local coordinate system. The plurality of items may be presented using the local coordinate system. The method may additionally include mapping the set of predetermined coordinates of a chosen item of the selected items in a [0,0,1,1] coordinate system to a set of transformed coordinates for the predetermined geometric shape of the chosen item. The set of transformed coordinates allow presentation of the chosen item in the coordinate system of the graphical display. The chosen item may be displayed in the predetermined geometric shape using the set of transformed coordinates without varying the layout of the chosen item and reverting to a previously used coordinate system.

### BACKGROUND

Aspects of the present invention relate to graphical displays, interactive data visualizations or similar presentations, such as treemap visualizations or other graphical displays, and more particularly to a method, system and computer program product for focus-change invariance in a graphical display.

Interactive data visualizations, such as treemaps are gaining popularity and traction. A treemap is a display technique that allows presentation of a hierarchy of data items in a very compact form. However, treemaps present a number of ergonomic issues. For example, preserving the consistency of the display may be difficult when navigating various levels of a hierarchy (focus in or focus out of a node). Variations of the layout of the display may result when focusing in (zooming in) or focusing out (zooming out) on selected nodes or portions of the treemap. The aspect ratio (defined as width over height of a rectangle) of the available display area has an influence on the treemap layout algorithms on the content of the treemap. When focusing in on a treemap node, a best aspect ratio of the node can become different from the initial display area in the expanded mode. Existing treemap focus-change methods do not relay-out the node or do not take advantage of the full available space, resulting in a sub-optimal display. Other treemap focus-change methods do relay out the node, resulting in discontinuities in the perception of the node between its focused-out and focused-in versions. FIG. 1A is a representation of an example of a prior art interactive treemap visualization 100. The node or item “Highway Infrastructure” 102 identified by a broken line in FIG. 1A may be selected to apply a focus-in or zoom-in feature. After zooming-in, the expanded visualization may appear as in FIG. 1B. FIG. 1B is a representation of the example of the interactive treemap visualization of FIG. 1A in which a focus-change has been applied or activated on the selected node or item 102 of the treemap 100. As illustrated in FIG. 1B the available space or display area is not completely used resulting in a sub-optimal display.

FIG. 2A is a representation of another example of a prior art interactive treemap visualization 200. The node or item “Water” 202 enclosed in a broken line may be selected to apply the focus-in or zoom-in feature. FIG. 2B is a representation of the example of the interactive treemap visualization of FIG. 2A in which the focus-change has been applied or activated on the selected node or item 202 of the treemap 200. As illustrated in FIG. 2B, the resulting expanded node 202 may result in confusion because inner nodes or items 204-208 may shuffled around as indicated by comparing the inner nodes or items 204-206 in FIGS. 2A and 2B.

Accordingly, nodes or items laid out to be shown in a particular aspect ratio, such as a “vertical” aspect ratio may look distorted and/or internal features may be rearranged when made to fit in a different display area, such as a horizontal space which causes the node or item to be displayed flatter than it is tall.

### BRIEF SUMMARY

According to an aspect of the present invention, a method for laying out nodes in a graphical display or treemap, which includes laying them out as if nodes were embedded in a square space of coordinates [0,0,1,1], allows handling focus-change in this graphical display without producing sub-optimal displays nor visual discontinuities between focus states. Embedding all nodes in a square space takes into considering that treemap layout algorithms attempt to make the nodes as square as possible in all circumstances and that nodes that become very elongated (either vertically or horizontally) remain unreadable in all circumstances. Embedding the nodes in the square space ensures that nodes will keep their appearance and ordering regardless of the aspect ratio in which they may be displayed and this aspect ratio will always be close to the optimal. By embedding all nodes in the square space or shape, the layout of the treemap needs to be computed only once, before any visual presentation of the data. The nodes may then be shown in multiple views at differing sizes, aspect ratios and focus levels, while maintaining visual consistency without any variance of the item or node and any internal features of the item in focus-change operations.

According to an aspect of the present invention, a method to draw a plurality of items inside a graphical shape, while preserving focus change invariance may include computing, by a processor, selected items of a plurality of items in the graphical display for presentation of each selected item in a predetermined geometric shape within the graphical display. The predetermined geometric shape may include a set of predetermined coordinates in a local coordinate system of the graphical display. The method may also include presenting, by the processor on a display associated with the processor, the plurality of items in the graphical display using the local coordinate system of the graphical display in response to the graphical display being selected for presentation. The method may additionally include mapping, by the processor, the set of predetermined coordinates of a chosen item of the selected items, in a [0,0,1,1] coordinate system to a set of transformed coordinates for the predetermined geometric shape of the chosen item. The set of transformed coordinates allow presentation of the chosen item in the coordinate system of the graphical display. The method may further include displaying on the display the chosen item in the predetermined geometric shape using the set of transformed coordinates without varying the layout of the chosen item and reverting to a previously used coordinate system.

According to another aspect of the present invention, a system to draw a plurality of items inside a graphical shape, while preserving focus change invariance may include a processor and a module operating on the processor to compute selected items of a plurality of items in the graphical display for presentation of each selected item in a predetermined geometric shape within the graphical display. The predetermined geometric shape may include a set of predetermined coordinates in a local coordinate system of the graphical display. A display associated with the processor may present the plurality of items in the graphical display using the local coordinate system of the graphical display in response to the graphical display being selected for presentation. The system may also include a module to map the set of predetermined coordinates of a chosen item of the selected items, in a [0,0,1,1] coordinate system to a set of transformed coordinates for the predetermined geometric shape of the chosen item. The set of transformed coordinates allow presentation of the chosen item in the coordinate system of the graphical display and the display displays the chosen item in the predetermined geometric shape using the set, of transformed coordinates without varying the layout of the chosen item. The method may further include a module to revert to a previously used coordinate system.

According to a further aspect of the present invention, a computer program product to draw a plurality of items inside a graphical shape, while preserving focus change invariance may include a computer readable storage medium having computer readable program code embodied therewith. The computer readable program code may include computer readable program code configured to compute selected items of a plurality of items in the graphical display for presentation of each selected item in a predetermined geometric shape within the graphical display. The predetermined geometric shape may include a set of predetermined coordinates in a local coordinate system of the graphical display. The computer readable program code may also include computer readable program code configured to present the plurality of items in the graphical display using the local coordinate system of the graphical display in response to the graphical display being selected for presentation. The computer readable program code may also include computer readable program code configured to map the set of predetermined coordinates of a chosen item of the selected items, in a [0,0,1,1] coordinate system to a set of transformed coordinates for the predetermined geometric shape of the chosen item. The set of transformed coordinates allow presentation of the chosen item in the coordinate system of the graphical display. The computer readable program code may also include computer readable program code configured to display the chosen item in the predetermined geometric shape using the set of transformed coordinates without varying the layout of the chosen item. The computer readable program code may further include computer readable program code configures to revert to a previously used coordinate system.

### BRIEF DESCRIPTION OF THE SEVERAL VIEWS OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1A is a representation of an example of a prior art interactive treemap visualization.

FIG. 1B is a representation of the example of the interactive treemap visualization of FIG. 1A in which a focus-change has been applied or activated on a selected node or item of the tree map.

FIG. 2A is a representation of another example of a prior art interactive treemap visualization.

FIG. 2B is a representation of the example of the interactive treemap visualization of FIG. 2A in which a focus-change has been applied or activated on a selected node or item of the tree map.

FIG. 3 is a flow chart of an example of a method for focus-change invariance in a graphical display in accordance with an embodiment of the present invention.

FIG. 4A is a representation of an example of an interactive treemap visualization in accordance with an embodiment of the present invention.

FIG. 4B is a representation of the example of the interactive treemap visualization of FIG. 4A in which a focus-change has been applied or activated on a selected node or item of the treemap in accordance with an embodiment of the present invention.

FIG. 5 is a block schematic diagram of an example of a system for focus-change invariance in a graphical display in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

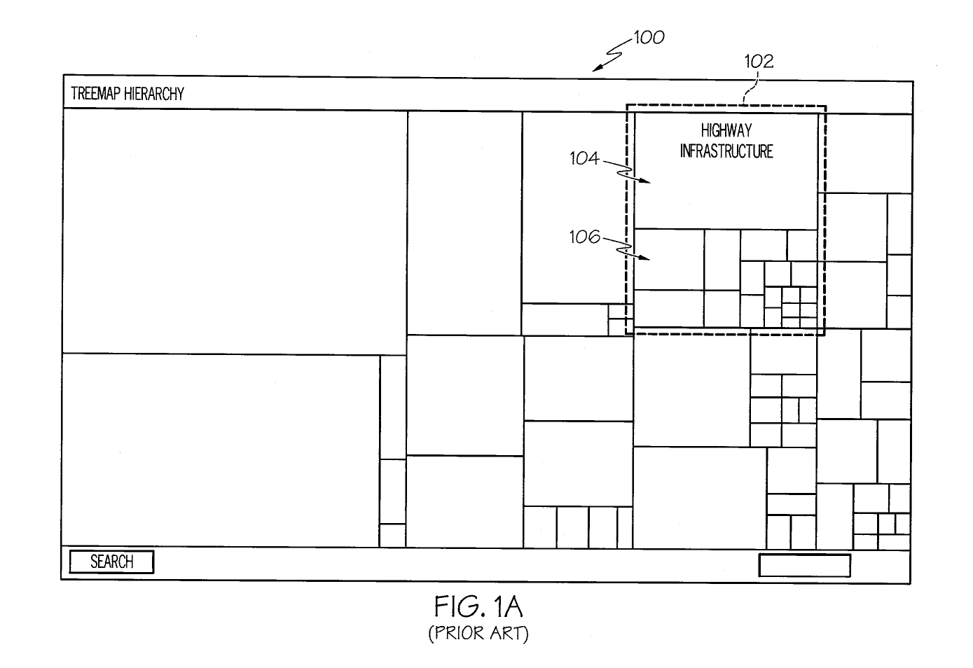

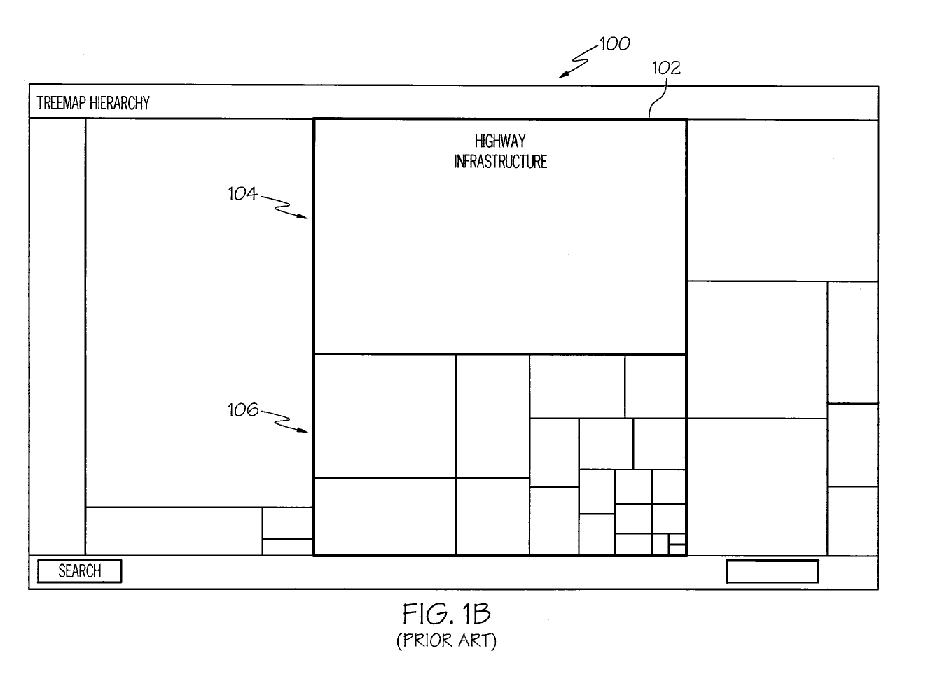

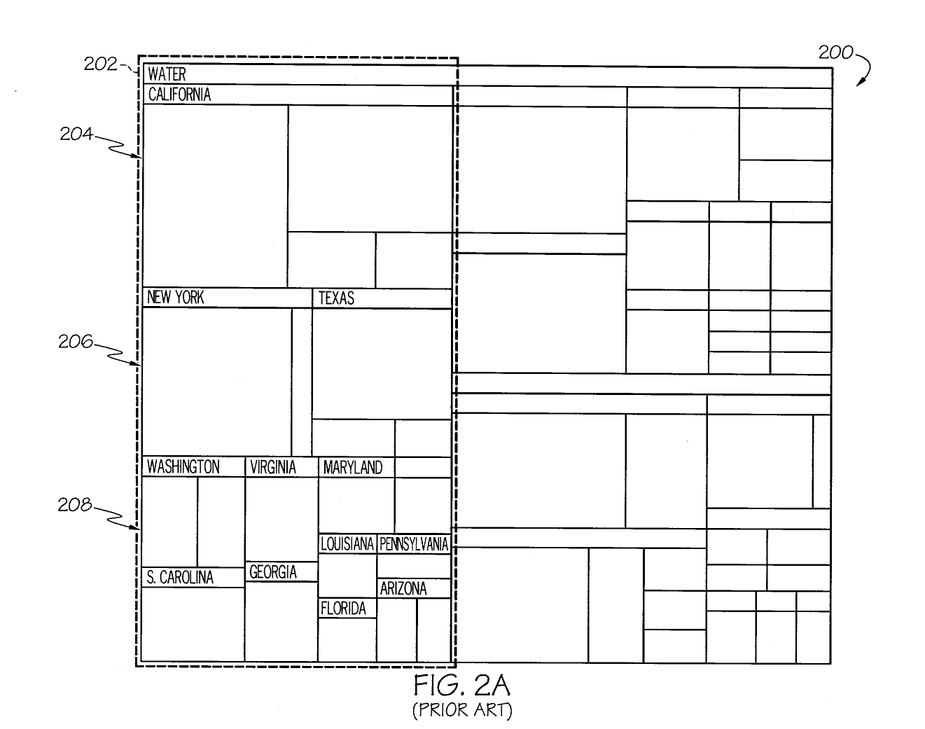

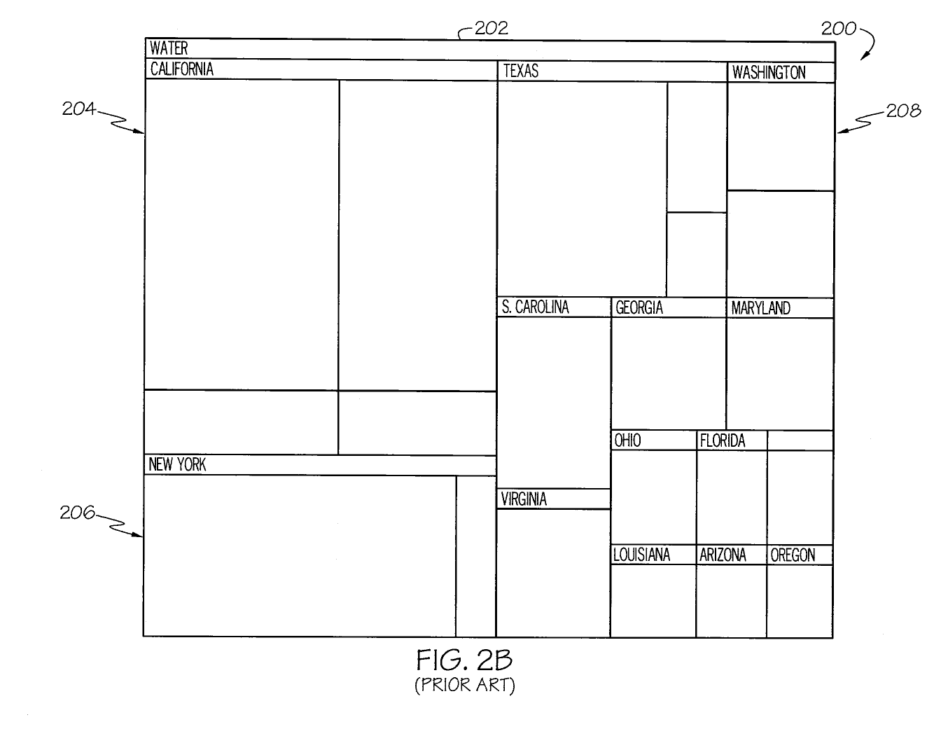

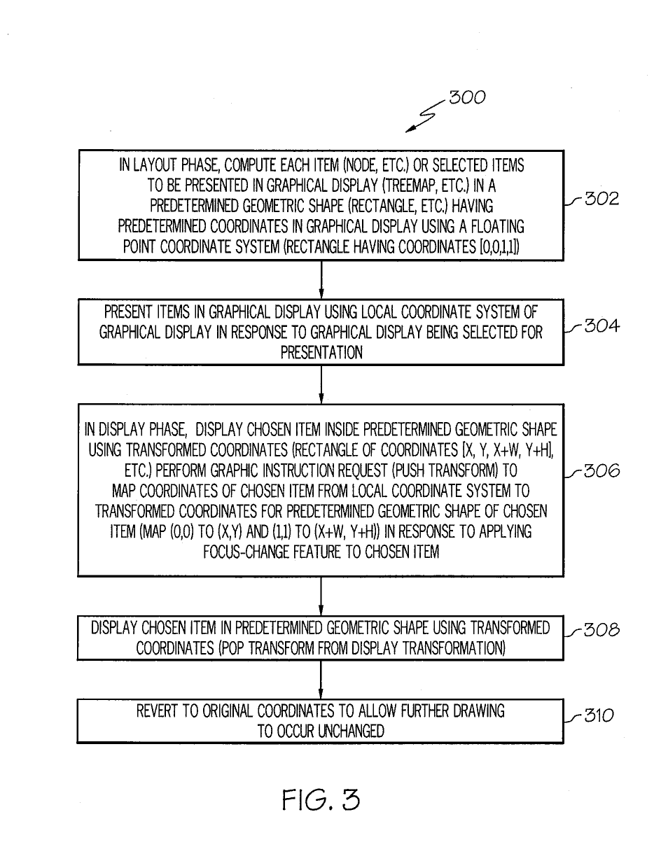

FIG. 3 is a flow chart of an example of a method 300 for focus-change invariance in a graphical display in accordance with an embodiment of the present invention. In block 302, each item or selected items to be presented in a graphical display may be computed or configured to be presented or displayed in a predetermined geometric shape. Each item or selected item may be computed or configured to be presented in the predetermined geometric shape in a layout phase of creating the graphical display. As used herein, graphical display may be any interactive data visualization, such as a treemap visualization or other type interactive data visualization for presenting a hierarchy of data items in a compact or concise format. As used herein, item may include a group of items, a node, a group of nodes or similar term representing or including data or content in a graphical display. Each item may also include a plurality of inner items or sub-items similar to the inner items or sub-items illustrated in FIGS. 1A, 1B, 2A, and 2B by reference numerals 104, 106, 204, 206 and 208, respectively.

The predetermined geometric shape of the item in the graphical display has predetermined coordinates. The predetermined coordinates may use a floating point coordinate system. The predetermined coordinates may also use a local coordinate system of the graphical display.

The predetermined geometric shape may be a rectangle or rectangular form. Accordingly, the predetermined geometric shape may be a rectangle having coordinates of [0, 0, 1, 1] in a floating point coordinate system which corresponds to the local coordinate system of the graphical display. Although the invention is not intended to be limited by the type or form of the predetermined geometric shape used as other shapes may be appropriate depending on the layout of a particular graphical display.

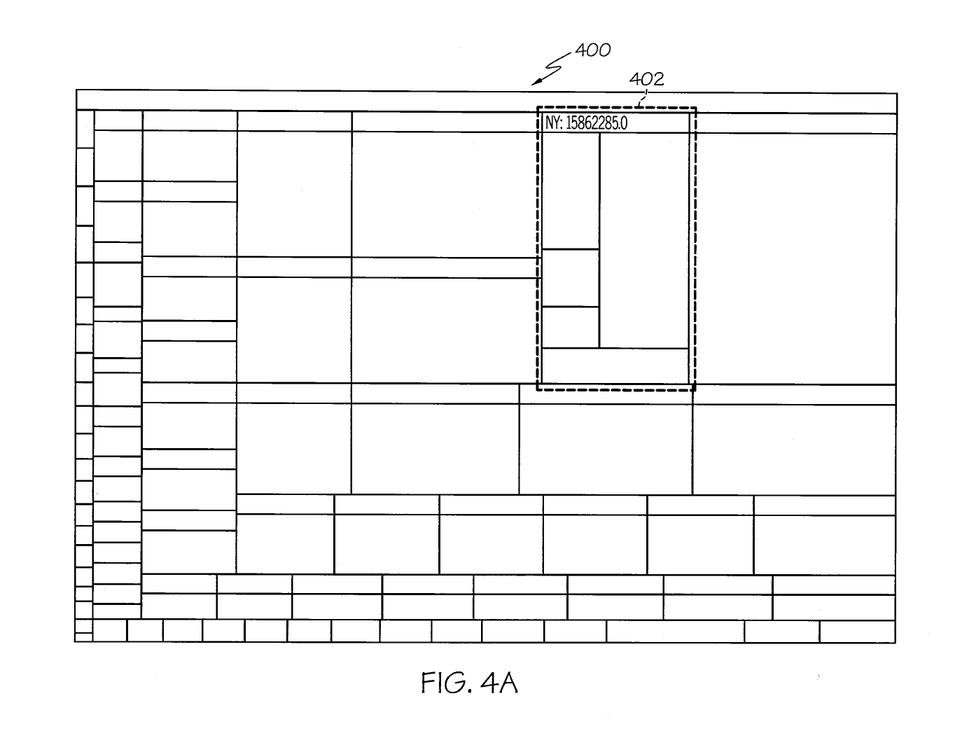

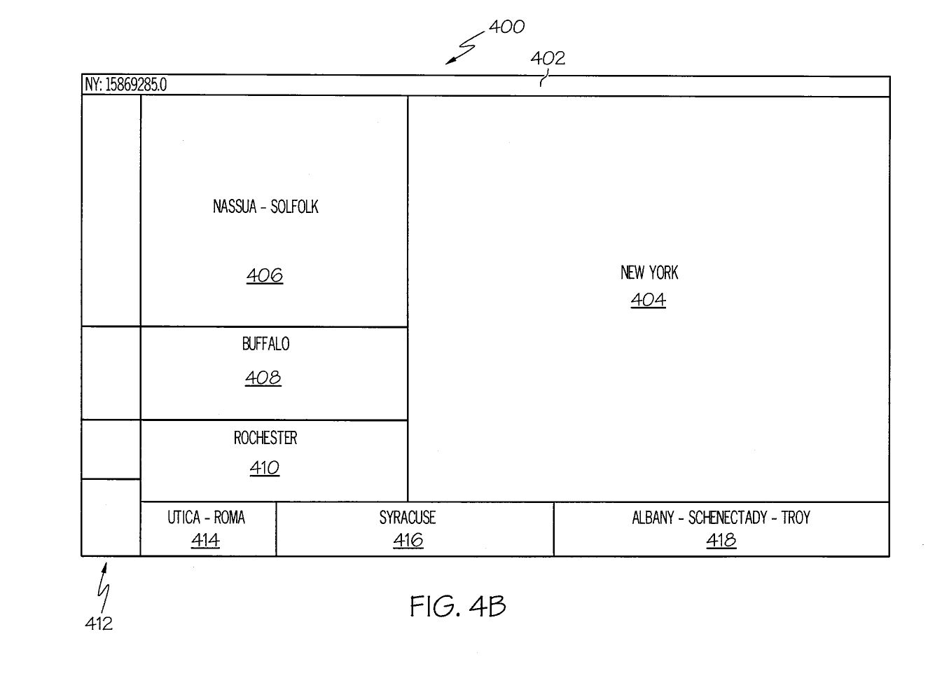

In block 304, items in the graphical display may be presented using the local coordinate system of the graphical display in response to the graphical display being selected for presentation. Referring also to FIGS. 4A and 4B, FIG. 4A is a representation of an example of a graphical display 400, in this example an interactive treemap visualization, in accordance with an embodiment of the present invention. FIGS. 4A and 4B illustrate a display phase of a graphical display or interactive data visualization.

In block 306, item 402 may be chosen in the graphical display 400 to apply a focus-change feature. The item 402 inside the predetermined geometric shape is displayed using transformed coordinates. In the example illustrated in FIGS. 4A and 4B the focus-change feature illustrated is a focus-in or zoom-in feature. FIG. 4B is a representation of the example of the interactive treemap visualization 400 of FIG. 4A in which the focus-change (zoom-in effect) has been applied or activated on the chosen item 402 of the graphical display 400 or treemap in accordance with an embodiment of the present invention. In the example illustrated in FIGS. 4A and 4B predetermined geometric shape is a rectangle and the chosen item 402 is displayed and FIG. 4B using transformed coordinates of the rectangle corresponding to coordinates [x, y, x+w, y+h].

In block 306, a graphic instruction request, for example, a push transformation is performed on the chosen item 402 to map coordinates of the chosen item 402 from the local coordinate system of the graphical display 400 in FIG. 4A to the transformed coordinates for the predetermined geometric shape of the chosen item 402 (as illustrated in FIG. 4B) in response to applying the focus-change feature to the chosen item 402 in FIG. 4A. Accordingly, the rectangle containing the chosen item 402 having coordinates [0, 0, 1, 1] in FIG. 4A is mapped or transformed by mapping coordinates (0, 0) in FIG. 4A to coordinates (x, y) in FIG. 4B and coordinates (1, 1) in FIG. 4A to coordinates (x+w, y+h) in FIG. 4B.

In block 308, the chosen item 402 is displayed in the predetermined geometric shape using the transformed coordinates as illustrated in the example in FIG. 4B. The transformed chosen item 402 is popped from the display transformation. As illustrated in the example of FIGS. 4A and 4 B, the inner items 404-418 or sub-items maintain a substantially consistent form in the focus-change visualization between FIGS. 4A and 4B without varying the layout of the chosen item 402 and the inner items 404-418 in the expanded focus visualization. Thus, the chosen item 402 is presented on a display in the predetermined geometric shape using the set of transformed coordinates without varying the layout of the chosen item 402 and inner items 404-418.

In block 310, the original coordinate system of the graphical display 400 is restored to allow further drawing to occur unchanged.

Focus change, zoom in or out and graphical display resizing events triggered by the user or another external event have no effect on the layout and display phases: the method goal is in effect to render the layout and display methods invariant to those external changes, all the while ensuring legibility of the display.

In an example of an embodiment of the present invention, modifications in the layout of any kind of treemap layout algorithm may be made. An input data structure may be provided including a tree structure of items with associated sizes (or weights), and a rectangle including coordinates (x,y,w,h) to fit the items in. The tree structure may be presented in the following, recursive, data-structure:

struct Node {

number weight;
// weight is the sum of all the children's weights,

computed transitively.

Node children[ ];

}

The treemap is rendered on screen using a common graphic engine as found on most modern day operating systems, providing the capability to draw graphic primitives in a floating point-based coordinate system, thus providing the possibility to use floating-point based affine transforms to change the coordinate system in which graphic primitives are specified. For example, see Java2D (http://download.oracle.com/javase/1.4.2/docs/api/java/awt/Graphics2D.html), OpenGL (http://graphicstutorials.net/opengl_tutorials.php?page=2&tut=6&name=OpenGL%20Tutorial%206%20Transformations), GDI+rendering engines, for instance).

All drawing instructions issued to the graphic system occur in the context of a current transform that specify the coordinate transform to be applied to graphic coordinates before they are mapped on screen. At least two instructions are used: pushTransform(affine transform) takes an affine transform matrix and post multiplies it to the current transform, and popTransform( ) reverts the effect of the last pushTransform called.

Then, one among a variety of treemap algorithms may be used. Any known space-filling layout can be used, such as those described in [http://www.cs.umd.edu/hcil/treemap-history/]. An embodiment of the invention described below inserts a few specific steps in those algorithms, at the layout computation and rendering stages. At the layout phase where rectangles corresponding to each item are computed, the input rectangle in which items are fitted is a rectangle of coordinates [0,0,1,1] using a floating point coordinate system. At the display or rendering phase, when a particular group of items is displayed inside a rectangle of coordinates [x,y,x+w,y+h]: (1) a graphic instruction (pushTransform) request is performed, pushing a local coordinate system that maps (0,0) to (x,y), and (1,1) to (x+w,y+h); (2) the rectangles computed for the items are used as they have been computed; and (3) the transform is popped from the display transformation.

The following describes an example of an embodiment of the invention applied to an exemplary slice and dice treemap algorithm. An example of the slice and dice algorithm may be found at http://hcil.cs.umd.edu/trs/91-03/91-03.html. The pseudo code may be written as:

| | |
|---|---|
| 1 | SliceAndDiceTreemap(Node node, Rectangle r, boolean axis) |
| { | |

| | |
|---|---|
| 2 | paint(r); |
| 3 | number span = node.weight/(axis?r.width:r.height); |
| 4 | number accum=0; |
| 5 | foreach(n in node.children) { |

| | |
|---|---|
| 6 | Rectangle r2; |
| 7 | if(axis) r2=(x: accum + r.x, y: r.y |

| | |
|---|---|
| 8 | width: n.weight/span, height: r.height); |

| | |
|---|---|
| 9 | else r2=(x: r.x, y: accum + r.y |

| | |
|---|---|
| 10 | width: r.width, height: n.weight/span); |

| | |
|---|---|
| 11 | SliceAndDiceTreemap(n, r2, !axis); |
| 12 | accum = accum + n.weight/span; |

| | |
|---|---|
| 13 | } |

| | |
|---|---|
| 14 | } |

Wherein line 2 paints the current node in rectangle r, line 3 initialize a span variable which represents the ratio of total weight of all the nodes to be drawn over total span of the rectangle to draw into, line 4 initializes an accumulator variable to 0, lines 5 to 12 iterate over all children nodes to draw them recursively through the steps of: line 7 to 10, compute an inner rectangle that spans full height if the axis variable is true, or full width if the axis variable is false, and spans an area proportional to the weight of the node in the other dimension; line 11 recursively calls the drawing method to draw the sub tree into its allocated space, and line 12 increments the accumulated span already drawn.

The algorithm may then be transformed in accordance with an embodiment of the invention as follows, still in pseudo code:

| | |
|---|---|
| 1 | ZoomInvariantSliceAndDiceTreemap(Node node, Rectangle r, |

| boolean axis) { | |
|---|---|
| 2 | AffineTransform t; |
| 3 | t.translate(r.x,r.y); |
| 4 | t.scale(r.width, r.height); |
| 5 | pushTransform(t); |
| 6 | paint(Rectangle(0,0,1,1)); |
| 7 | number span = node.weight; |
| 8 | number accum=0; |
| 9 | foreach(n in node.children) { |

| | |
|---|---|
| 10 | Rectangle r2; |
| 11 | if(axis) r2=(x: accum, y: 0, |

| | |
|---|---|
| 12 | width: n.weight/span, height: 1); |

| | |
|---|---|
| 13 | else r2=(x: 0, y: accum, |

| | |
|---|---|
| 14 | width: 1, height: n.weight/span); |

| | |
|---|---|
| 15 | ZoomInvariantSliceAndDiceTreemap(n, r2, !axis); |
| 16 | accum = accum + n.weight/span; |

| | |
|---|---|
| 17 | } |
| 18 | popTransform( ); |

| | |
|---|---|
| 19 | } |

Wherein the modified parts are:
1—change of the drawing coordinate system:
   a. lines 2-5 are added to change the local coordinate system to a coordinate system whose origin is the lower left corner of the rectangle r passed in as argument (line 3), and the top right corner of the rectangle r is at coordinates (1,1) (line 4).
   b. line 18 reverts the effect of line 5, restoring the current coordinate system to what it was before.
2—changes in the parameters to take into account the fact the coordinate system has changed:
   a. line 6, paint the surface of coordinate (0,0,1,1) which now match the exact same region as the r passed in parameter, considering the effect of line 5
   b. line 7: now that width and height are both 1, the process of dividing span by the width or height of r may be economized.
   c. lines 11 to 14: now that the rectangle r has been mapped to the (0,0,1,1) coordinate system, references to the rectangle coordinates can be dropped in the call, replacing r.x and r.y with 0 and r.width and r.height with 1.

The following describes an example of an embodiment of the invention applied to an exemplary Pivot by Middle layout algorithm. The transformation of a Pivot by Middle layout algorithm follows the same principles described at http://coitweb.uncc.edu/˜krs/courses/6010/infovis/pubs/hier/wattenberg.pdf.

If the regular Pivot by Middle algorithm reads:

| | |
|---|---|
| 1 | PivotByMiddleTreemap(Node nodes[ ], number weight, |

| Rectangle r, boolean axis) { | |
|---|---|
| 2 | paint(r); |
| 3 | number halfspan=sum(nodes[0..nodes.size/2], weight); |
| 4 | if(halfspan>0) { |

| | |
|---|---|
| 5 | Rectangle r2(r.x,r.y, |

| | |
|---|---|
| 6 | axis?halfspan/weight*r.width:r.width, |
| 7 | axis?r.height:halfspan/weight*r.height); |

| | |
|---|---|
| 8 | PivotByMiddleTreemap ( |

| | |
|---|---|
| 9 | nodes[0..nodes.size/2], halfspan, r2, !axis); |

| | |
|---|---|
| 10 | } |
| 11 | if(weight-halfspan>0) { |

| | |
|---|---|
| 12 | Rectangle r3(axis?r2.x:r.x, |

| 13 | axis?r.y:r2.y, |
|---|---|
| 14 | axis?(weight- |
| halfspan)/weight*r.width:r.width, | |
| 15 | axis?r.height:(weight- |

| halfspan)/weight*r.height); | |
|---|---|
| 16 | PivotByMiddleTreemap ( |

| | |
|---|---|
| 17 | nodes[nodes.size/2..nodes.size], |
| 18 | weight-halfspan, r3, !axis); |

| | |
|---|---|
| 19 | } |

| | |
|---|---|
| 20 | } |

The focus-change invariant or zoom invariant in accordance with an embodiment of the invention is:

| 1 | ZoomInvariantPivotMiddleTreemap(Node nodes[ ], number |
|---|---|
| weight, Rectangle r, boolean axis) { | |
| 2 | AffineTransform t; |
| 3 | t.translate(r.x,r.y); |
| 4 | t.scale(r.width, r.height); |
| 5 | pushTransform (t); |
| 6 | Rectangle r2(0,0,1,1); |
| 7 | paint(r2); |
| 8 | number halfspan=sum(nodes[0..nodes.size/2], weight); |
| 9 | if(halfspan>0) { |

| | |
|---|---|
| 10 | Rectangle r3(0,0, |

| | |
|---|---|
| 11 | axis?halfspan/weight:1, |
| 12 | axis?1:halfspan/weight); |

| | |
|---|---|
| 13 | ZoomInvariantPivotMiddleTreemap( |

| | |
|---|---|
| 14 | nodes[0..nodes.size/2],halfspan, r2, !axis); |

| | |
|---|---|
| 15 | } |
| 16 | if(weight-halfspan>0) { |

| | |
|---|---|
| 17 | Rectangle r3(axis? halfspan/weight:0, |

| | |
|---|---|
| 18 | axis?0:halfspan/weight, |
| 19 | axis?(weight-halfspan)/weight:1, |
| 20 | axis?1:(weight-halfspan)/weight); |

| | |
|---|---|
| 21 | ZoomInvariantPivotMiddleTreemap( |

| | |
|---|---|
| 22 | nodes[nodes.size/2..nodes.size], |
| 23 | weight-halfspan, r3, !axis); |

| | |
|---|---|
| 24 | } |
| 25 | popTransform( ); |
| 26 | } |

Wherein the modified parts are:
1—change of the drawing coordinate system:
   a. lines 2-5 are added to change the local coordinate system to a coordinate system whose origin is the lower left corner of the rectangle r passed in as argument (line 3), and the top right corner of the rectangle r is at coordinates (1,1) (line 4).
   b. line 25 reverts the effect of line 5, restoring the current coordinate system to what it was before.
2—changes in the parameters to take into account the fact the coordinate system has changed:
   c. line 6-7, paint the surface of coordinate (0,0,1,1) which now match the exact same region as the r passed in parameter, considering the effect of line 5
   d. lines 10 to 12 and 17 to 20: now that the rectangle r has been mapped to the (0,0,1,1) coordinate system, we can drop references to its coordinates in the call, replacing r.x and r.y with 0 and r.width and r.height with 1.

From the foregoing examples, those skilled in the art will recognize how to adapt a treemap algorithm to include the focus-change invariant features of the present invention.

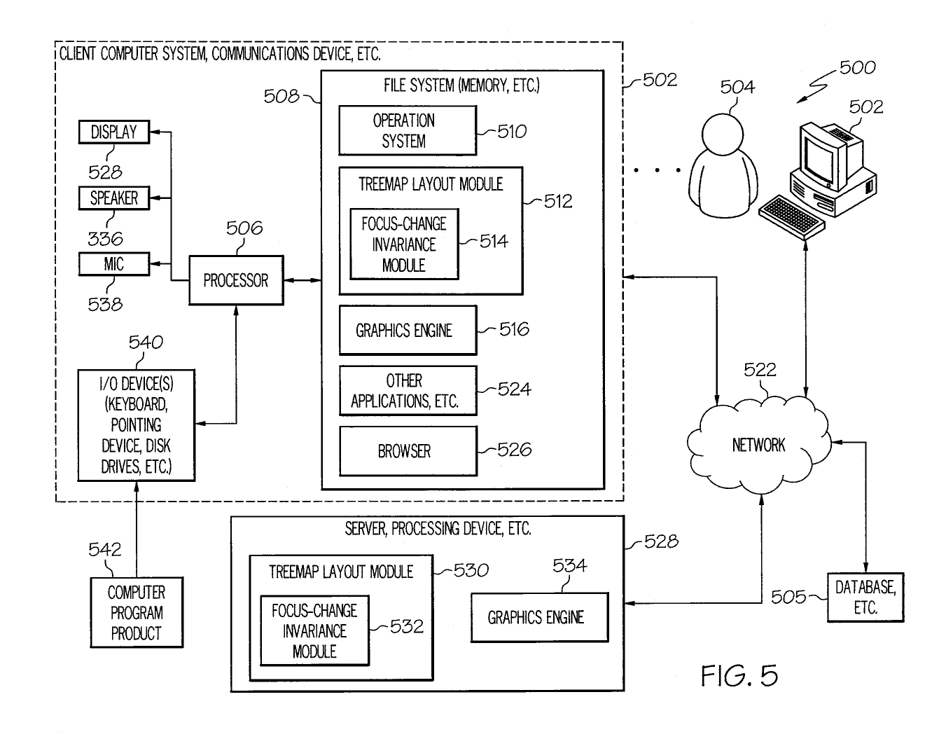

FIG. 5 is a block schematic diagram of an example of a system 500 for focus-change invariance in a graphical display in accordance with an embodiment of the present invention. The method 300 and other exemplary features described herein may be embodied in or performed by the system 500 or components of the system 500 as described below. The system 500 may include a computer system 502 for use by a user 504 for forming graphical display or interactive data visualization from a database 505 or other storage device and may perform focus-change invariance operations similar to those described herein. The computer system 502 may be any type of computer device capable of performing the functions or operations described herein. The database 505 may be accessible over a network, such as network 522 or may be associated with the computer system 502.

The computer system 502 may include a processor 506 to control operation of the computer system 502 and a file system 508, memory or similar data storage device. An operating system 510 may be stored on the file system 508 for running or operating on the processor 506. A graphical display module, such as treemap layout module 512 or other data visualization program may be stored on the file system 508 for operation on the processor to perform the functions and operations described herein. The method 300 and other programs described herein may be embodied in the treemap layout module 512. The treemap layout module 512 may also include a focus-change invariance module 514 for performing focus-change operations without varying a layout of a chose item similar to that described herein.

A graphics engine may also be stored on the file system 508 for operation on the processor 506 for displaying or presenting graphical displays or interactive visualizations on a display 518 of the computer system 502.

Other applications 524, software programs or the like may also be stored on the file system 508 for operation on the processor 506. A web or Internet browser 526 may also be stored on the file system 508 for accessing one or more resources, such as a server 528 via the network 522. The network 522 may be the Internet, intranet or other network.

In accordance with an embodiment, the server 528 or processing device may include a treemap layout module 530 including a focus-change invariance module 532. The treemap layout module 530 may be the same as treemap layout module 512 on computer system 502. The treemap layout module 530 on the server 528 may be provided in addition to the treemap layout module 512 on the computer system 502. In another embodiment, only the treemap layout module 530 on the server 528 may be provided, such as in a cloud computing environment or similar arrangement. The treemap layout module 530 would then be accessed via the network 522 using the browser 526 of the computer system or computing device 502. In a further embodiment, treemap layout module 530 may perform some of the operations described herein and treemap layout module 512 on the server 528 may perform other functions described herein.

The server 528 may also include a graphics engine 534. The graphics engine 534 may be substantially the same as the graphics engine 516 on the computer system 502. In at least one embodiment, the graphics engine 534 may be provided rather than the graphics engine 516 on the computer system 502, such as in a cloud computing architecture. In other embodiments, both graphics engines 516 and 534 may be provided or only graphics engine 516 on the computer system 502.

As previously discussed, the computer system 502 may also include a display 528 for presenting graphical displays as well as other content. The computer system 502 may also include a speaker system 536 for presenting any audio content. The computer system 502 may additionally include a microphone 538 for the user 504 to aurally communicate via the computer system 502.

The computer system 502 may further include one or more input devices, output devices or combination input/output devices, collectively I/O devices 540. The I/O devices 540 may include a keyboard, pointing device, such as a mouse or other computer pointing device, disk drives and any other devices to permit a user, such as user 504, to interface with and control operation of the computer system 502 and network resources, such as server 528. The treemap layout module 512 may be loaded on the computer system 502 from a computer program product, such as computer program product 542 using one of the input devices 540. The computer program product 542 may be embodied in a form similar that previously described.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A method to draw a plurality of items inside a graphical shape, while preserving focus change invariance, comprising:
computing, by a processor, selected items of a plurality of items in the graphical display for presentation of each selected item in a predetermined geometric shape within the graphical display, wherein the predetermined geometric shape includes a set of predetermined coordinates in a local coordinate system of the graphical display;
presenting, by the processor on a display associated with the processor, the plurality of items in the graphical display using the local coordinate system of the graphical display in response to the graphical display being selected for presentation;
mapping, by the processor, the set of predetermined coordinates of a chosen item of the selected items, in a [0,0,1,1] coordinate system to a set of transformed coordinates for the predetermined geometric shape of the chosen item, wherein the set of transformed coordinates allow presentation of the chosen item in the coordinate system of the graphical display;
displaying on the display the chosen item in the predetermined geometric shape using the set of transformed coordinates without varying the layout of the chosen item; and
reverting to a previously used coordinate system.

2. The method of claim 1, wherein computing, by the processor, the selected items comprises computing the selected items of the plurality of items in the graphical display for presentation of each selected item in a rectangular form.

3. The method of claim 2, further comprising setting the predetermined coordinates for the rectangular form at a given x-coordinate, y-coordinate, width and height.

4. The method of claim 3, further comprising setting the predetermined coordinates for the rectangular form at (0, 0, 1, 1).

5. The method of claim 1, wherein computing, by the processor, the selected items comprises computing the selected items of the plurality of items in the graphical display for presentation in the predetermined geometric shape using a floating point coordinate system.

6. The method of claim 1, wherein computing, by the processor, the selected items comprises computing the selected items of the plurality of items in the graphical display for presentation in a rectangle having predetermined coordinates using a floating point coordinate system.

7. The method of claim 6, wherein the rectangle has coordinates of (0, 0, 1, 1), the method further comprising transforming the coordinates of the rectangle to (x, y, x+w, y+w).

8. The method of claim 1, wherein computing, by the processor, the selected items comprises computing each item of the plurality of items in the graphical display for presentation in the predetermined geometrical shape within the graphical display.

9. The method of claim 1, wherein the graphical display comprises a treemap.

10. The method of claim 9, further comprising laying out the treemap using a slice and dice algorithm.

11. The method of claim 9, further comprising laying out the treemap using a pivot by middle layout algorithm.

12. The method of claim 9, further comprising laying out the treemap using a squarified and ordered layout algorithm.

13. A system to draw a plurality of items inside a graphical shape, while preserving focus-change invariance in a graphical display, comprising:
a processor;
a module operating on the processor to compute selected items of a plurality of items in the graphical display for presentation of each selected item in a predetermined geometric shape within the graphical display, wherein the predetermined geometric shape includes a set of predetermined coordinates in a local coordinate system of the graphical display;
a display associated with the processor for presenting the plurality of items in the graphical display using the local coordinate system of the graphical display in response to the graphical display being selected for presentation;
a module to map the set of predetermined coordinates of a chosen item of the selected items, in a [0,0,1,1] coordinate system to a set of transformed coordinates for the predetermined geometric shape of the chosen item, wherein the set of transformed coordinates allow presentation of the chosen item in the coordinate system of the graphical display, the display displaying the chosen item in the predetermined geometric shape using the set of transformed coordinates without varying the layout of the chosen item; and
a module to revert to a previously used coordinate system.

14. The system of claim 13, wherein the predetermined geometric shape comprises a rectangle.

15. The system of claim 13, wherein the predetermined geometric shape comprises coordinates in a floating point coordinate system.

16. The system of claim 13, wherein the predetermined geometric shape comprises a rectangle including the predetermined coordinates of (0, 0, 1, 1) and wherein the module to map the set of predetermined coordinates transforms the predetermined coordinates to transformed coordinates of (x, y, x+w, y+h) in response to the focus-change feature being applied to the chosen item.

17. A computer program product to draw a plurality of items inside a graphical shape, while preserving focus-change invariance in a graphical display, the computer program product comprising:
a computer readable storage medium having computer readable program code embodied therewith, the computer readable program code comprising:
computer readable program code configured to compute selected items of a plurality of items in the graphical display for presentation of each selected item in a predetermined geometric shape within the graphical display, wherein the predetermined geometric shape includes a set of predetermined coordinates in a local coordinate system of the graphical display;
computer readable program code configured to present the plurality of items in the graphical display using the local coordinate system of the graphical display in response to the graphical display being selected for presentation;
computer readable program code configured to map the set of predetermined coordinates of a chosen item of the selected items, in a [0,0,1,1] coordinate system to a set of transformed coordinates for the predetermined geometric shape of the chosen item, wherein the set of transformed coordinates allow presentation of the chosen item in the coordinate system of the graphical display;
computer readable program code configured to display the chosen item in the predetermined geometric shape using the set of transformed coordinates without varying the layout of the chosen item; and
computer readable program code configures to revert to a previously used coordinate system.

18. The computer program product of claim 17, further comprising computer readable program code configured to compute the selected items of the plurality of items in the graphical display for presentation of each selected item in a rectangular form.

19. The computer program product of claim 18, wherein the rectangular form includes coordinates of (0, 0, 1, 1) and wherein the computer readable program code further comprising computer readable program code configured to transform the coordinates of the rectangular form to (x, y, x+w, y+w).

20. The computer program product of claim 17, further comprising computer readable program code configured to lay out the graphical display using one of a slice and dice algorithm, a pivot by middle layout algorithm and a squarified and ordered layout algorithm.
